(19) United States
(12) Patent Application Publication
(10) Pub. No.: US 2020/0398901 A1
(43) Pub. Date: Dec. 24, 2020

(54) UPPER VEHICLE-BODY STRUCTURE FOR VEHICLE

(71) Applicant: Mazda Motor Corporation, Hiroshima (JP)

(72) Inventors: Daisuke KIYOSHITA, Hiroshima-shi (JP); Yoshikazu NISHIMURA, Hiroshima-shi (JP); Takeshi NAKAMURA, Hiroshima-shi (JP)

(73) Assignee: Mazda Motor Corporation, Hiroshima (JP)

(21) Appl. No.: 16/816,280

(22) Filed: Mar. 12, 2020

(30) Foreign Application Priority Data
Jun. 18, 2019 (JP) 2019-112727

(51) Int. Cl. B62D 25/06; B62D 25/04; B62D 29/00

(52) U.S. Cl. CPC B62D 25/06; B62D 27/02; B62D 29/002; B62D 25/04

(57) ABSTRACT

An upper vehicle-body structure for a vehicle includes a roof rail serving as a side part of a roof of the vehicle having an internal space defined therein that extends in a generally vehicle front-rear direction, a first pillar extending downward from the roof rail, a second pillar extending downward from the roof rail at a rearward position relative to the first pillar, a roof reinforcement extending from the roof rail toward a vehicle-width-direction inner side at a rearward position relative to the first pillar, and a filler in the internal space. The filler is in contact with an inner surface of the roof rail defining the internal space and suppresses changes in shape of the roof rail. The filler is in a region extending forward and rearward relative to a front edge of a connection portion of the roof rail with the roof reinforcement.

### CROSS REFERENCE TO RELATED APPLICATION

The present application contains subject matter related to Japanese Patent Application 2019-112727, filed in the Japanese Patent Office on Jun. 18, 2019, the entire contents of which being incorporate herein by reference in its entirety.

### TECHNICAL FIELD

The present disclosure relates to an upper vehicle-body structure for a vehicle including, e.g., a roof rail included in a vehicle-body upper side part so as to constitute a side part of a roof of the vehicle, the roof rail having an internal space defined therein, the internal space extending in a generally vehicle front-rear direction, a first pillar extending downward from the roof rail, e.g., a center pillar, a second pillar extending downward from the roof rail at a rearward position relative to the first pillar, e.g., an intermediate pillar, and a roof reinforcement extending from the roof rail toward a vehicle-width-direction inner side at a rearward position relative to the first pillar.

### BACKGROUND ART

A vehicle body upper structure has been commonly known as providing a solution to a roof rail in order to suppress deformation of the roof rail caused by a vehicle-width-direction inner side load applied to a center pillar at the time of a collision of the side of the vehicle (hereinafter, referred to as “side collision”), and then transmitted to the roof rail.

Meanwhile, for example, a joined portion of the roof rail with a roof reinforcement extending toward the vehicle-width-direction inner side at a rearward position relative to the center pillar (hereinafter, referred to as “rear-side roof reinforcement”) may receive an input of not only the load transmitted rearward from a joined portion of the roof rail with the center pillar at the time of a side collision, but also the load transmitted from an intermediate pillar positioned rearward relative to the center pillar through a joined portion of the roof rail with the intermediate pillar in some cases.

While the joined portion of the roof rail with the rear-side roof reinforcement is supported by this rear-side roof reinforcement from the vehicle-width-direction inner side, a portion of the roof rail, which is immediately in front of the joined portion, is not supported by the rear-side roof reinforcement. Thus, at the time of a side collision, due to the difference in rigidity between the joined portion and a portion immediately in front of this joined portion, a stress is more likely to become concentrated on a front edge of the joined portion. For this reason, there is an increased need for providing a solution to cross-sectional deformation of the roof rail in the vicinity of the front edge of the joined portion.

In one example, a roof side rail serving as a roof rail is reinforced by disposing a long reinforcement pipe in the interior of the roof side rail. The reinforcement pipe not only extends in the vicinity of the front edge of a joined portion of the roof side rail with a rear-side roof reinforcement, but also extends continuously in the vehicle-body front-rear direction from the rear relative to the rear-side roof reinforcement (to the front relative to a center pillar. Thus, weight of the roof side rail is increased.

### PRIOR ART DOCUMENT

### [Patent Document]

[Patent Document 1] JP-A-2009-57032

### SUMMARY

### Problems to be Solved

The present disclosure has been made in view of the above and other problems, and embodiments are directed to providing an upper vehicle-body structure for a vehicle, which can suppress breakage of a roof rail at its joined portion with a roof rail reinforcement caused by a vehicle-width-direction inner side load applied to a first pillar such as a center pillar at the time of a side collision, while minimizing an increase in weight of the roof rail.

### Means for Solving the Problems

The present disclosure is directed to an upper vehicle-body structure for a vehicle, the structure including: a roof rail included in a vehicle-body upper side part, the roof rail serving as a side part of a roof of the vehicle, the roof rail having an internal space defined therein, the internal space extending in a generally vehicle front-rear direction; a first pillar extending downward from the roof rail; a second pillar extending downward from the roof rail at a rearward position relative to the first pillar; a roof reinforcement extending from the roof rail toward a vehicle-width-direction inner side at a rearward position relative to the first pillar; and a filler in the internal space. The filler suppresses a change in shape of the roof rail in cross section perpendicular to a longitudinal direction of the roof rail. The filler is in contact with an inner surface of the roof rail, the inner surface defining the internal space. The filler is provided over a region extending forward and rearward relative to a front edge of the connection portion of the roof rail with the roof reinforcement.

With the above configuration, the upper vehicle-body structure for a vehicle can suppress breakage of the roof rail at its joined portion with the roof rail reinforcement caused by a vehicle-width-direction inner side load applied to the first pillar extending downward from the roof rail, such as a center pillar, at the time of a side collision, while minimizing an increase in weight of the roof rail.

In accordance with this aspect, the filler may be a high-rigidity foam.

With the above configuration, the high-rigidity foamed element can be foamed by heat used in a process of drying a painting agent painted on a vehicle-body surface, such that the high-rigidity foamed element comes into press-contact with a surface of the roof rail, which defines the internal space.

In accordance with this aspect, the connection portion of the roof rail with the roof reinforcement may at least partially align with a connection portion of the roof rail with the second pillar in a longitudinal direction of the roof rail, a vehicle body includes a plurality of closed cross-sectional members having respective closed cross-sectional spaces, and in and around a section where the connection portion of the roof rail with the roof reinforcement aligns with the joined portion of the roof rail with the second pillar in a vehicle-body front-rear direction, an annular structure formed of the closed cross-sectional members annularly surrounds a vehicle-interior space when viewed from front of the vehicle body, the roof rail, the roof reinforcement, and the second pillar may be included in the closed cross-sectional members, and respectively have the closed-cross sectional spaces defined therein, and the filler may be provided in or in a vicinity of a section of the roof rail, the section constituting a part of the annular structure.

With the above configuration, the deformation suppression member is provided in or in the vicinity of a section of the roof rail in the longitudinal direction, which constitutes a part of the annular structure, so that at the time of a side collision, the deformation suppression member can suppress cross-sectional deformation at the section of the roof rail in the longitudinal direction, and also load transmission from the second pillar through the deformation suppression member to the roof reinforcement can be effectively improved, and consequently this can contribute to improvement in rigidity of the annular structure.

In accordance with this aspect, the second pillar may include a second-pillar outer panel in a connection portion with the roof rail at least from a front edge to a rear edge of the filler on a vehicle-width-direction outer side relative to the filler.

With the above configuration, the deformation suppression member in its entirety in the vehicle front-rear direction can be provided on the vehicle-width-direction inner side relative to the second-pillar outer panel. Therefore, at the time of a side collision, for example, when a load input to the first pillar and transmitted from a door impact bar of a rear side door to the second pillar (second-pillar outer panel) is then input toward the vehicle-width-direction inner side relative to the joined portion of the roof rail with the second pillar, this load can be received by the deformation suppression member in its entirety in the vehicle front-rear direction. The deformation suppression member can thus suppress cross-sectional deformation of the roof rail at its joined portion with the second pillar.

In accordance with this aspect, the roof rail may include a front-side roof-rail inner portion and a rear-side roof-rail outer portion with a front edge thereof connected to a rear edge of the front-side roof-rail constituent member, and the upper vehicle-body structure may include the deformation suppression member at a position corresponding to a connection portion of the front-side and rear-side roof-rail constituent members in a longitudinal direction of the roof rail such that the deformation suppression member extends across the joined portion in a vehicle front-rear direction.

With the above configuration, the filler extends across the joined portion of the front-side and rear-side roof-rail constituent members in the vehicle front-rear direction, so that the filler can come into press-contact with an inner surface of the roof rail, which defines the internal space, such that the end portions of the front-side and rear-side roof-rail constituent members overlap one another in the connection portion. Thus, efficiency in transmitting and dispersing a side-collision load between the front-side and rear-side roof-rail constituent members can be improved, while deformation of the internal space at the connection portion in the longitudinal direction of the roof rail is suppressed.

Note that the roof rail may be divided into, and made up of, at least the front-side and rear-side roof-rail constituent members, so that between the front-side and rear-side roof-rail constituent members and a constituent member opposed to these roof-rail constituent members in the vehicle width direction so as to define therein a space, an adequate number of joining spots for spot welding or the like are provided, while the joining spots are provided at appropriate places, and then the front-side and rear-side roof-rail constituent members can be joined to the opposed constituent member.

Owing to this configuration, the roof-rail constituent members can be more firmly joined to another roof-rail constituent member opposed to these roof-rail constituent members in the vehicle width direction, as compared to the case where the roof rail is formed of a single member along the vehicle front-rear direction.

Note that, for example, at least either one of a roof-rail inner panel and a roof-rail outer panel can be employed as the roof-rail constituent members.

### Advantages of Embodiments

Embodiments set forth below in the present disclosure can suppress breakage of the roof rail at its joined portion with the roof rail reinforcement caused by a vehicle-width-direction inner side load applied to the first pillar such as the center pillar at the time of a side collision, while minimizing an increase in weight of the roof rail.

### BRIEF DESCRIPTION OF THE DRAWINGS

FIG. 1 is a perspective view of relevant parts of a vehicle including an upper vehicle-body structure according to an embodiment when viewed from the front and the right side of the vehicle body.

FIG. 2 is an enlarged cross-sectional view of the relevant parts taken along the line A-A in FIG. 1.

FIG. 3 is a perspective view of respective joined portions of a roof rail with an intermediate pillar and with a roof reinforcement, and around the joined portions when viewed from above with a roof rail outer portion removed.

FIG. 4 is a perspective view with an intermediate-pillar outer panel in FIG. 3 removed.

FIG. 5 is a perspective view of the respective joined portions of the roof rail with the intermediate pillar and with the roof reinforcement, and around the joined portions when viewed from below.

FIG. 6 (a) is a vertical cross-sectional view of the relevant parts of the vehicle including the upper vehicle-body structure according to the present embodiment when viewed from the vehicle-width-direction inner side, and (b) is a cross-sectional view taken along the line B-B in FIG. 6(a).

### DETAILED DESCRIPTION

An embodiment is described below in detail with reference to the drawings.

In the drawings, the arrow F, the arrow U, and the arrow OUT illustrate a vehicle front direction, a vehicle upper direction, and a vehicle-width-direction outer side (the right side of the vehicle), respectively. While FIG. 6(b) is a cross-sectional view taken along the line B-B in FIG. 6(a), only FIG. 6(b) illustrates a roof panel 28. Note that a side vehicle-body structure according to the present embodiment described below is provided approximately symmetrically on both the right and left sides of the vehicle. In the following descriptions, the vehicle-width-direction outer side is referred to as “vehicle-width outer side,” and the vehicle-width-direction inner side is referred to as “vehicle-width inner side.”

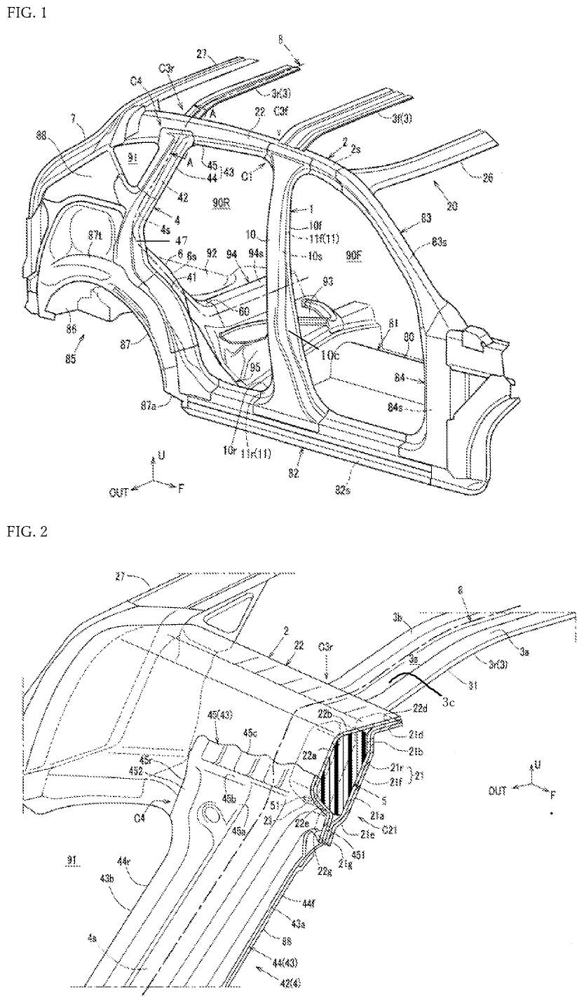

FIG. 1 is a perspective view of relevant parts of a vehicle including an upper vehicle-body structure according to the present embodiment when viewed from the front and the right side of the vehicle body.

As illustrated in FIG. 1, in the vehicle according to the present embodiment, a tunnel portion 80 extending in the vehicle front-rear direction at the vehicle-body lower part is formed together with a floor panel 81 into a single piece, or is formed integrally with the floor panel 81 At both the right and left end portions of the floor panel 81, a side sill 82 (only illustrated on the right side of the vehicle in FIG. 1) extends in the vehicle front-rear direction. At both the right and left side edges of a roof portion 20 of the vehicle, a roof rail 2 extends generally in the vehicle front-rear direction along each of these side edges (hereinafter, also referred to as “roof side rail”).

The side sill 82 and the roof rail 2 are both closed cross-sectional members (vehicle-body rigid members) respectively having a closed cross-sectional space 82s and a closed cross-sectional space 2s extending in their longitudinal direction (the vehicle front-rear direction).

Respective front edges of the side sill 82 and the roof rail 2 are connected by a front pillar 83 and a hinge pillar 84 that both extend in the up-down direction. The front pillar 83 extends obliquely downward to the front, and the rear upper end of the front pillar 83 is joined to the front edge of the roof rail 2. The hinge pillar 84 extends generally in the vertical direction. The upper end of the hinge pillar 84 is joined to the front lower end of the front pillar 83, while the lower end of the hinge pillar 84 is joined to the front edge of the side sill 82. The front pillar 83 and the hinge pillar 84 are both closed cross-sectional members (vehicle-body rigid members) respectively having a closed cross-sectional space 83s and a closed cross-sectional space 84s extending in their longitudinal direction (the up-down direction).

The side sill 82 and the roof rail 2 are connected at their respective intermediate portions in the vehicle front-rear direction by a center pillar 1 extending in the up-down direction between these intermediate portions.

The center pillar 1 includes a pillar outer panel 10 with a hat shape opened toward the vehicle-width inner side in cross section perpendicular to the up-down direction, e.g., has a convex portion 10c in a lower central region that protrudes in the out direction and flanges 10f, 10r on either side thereof, and a generally flat plate-like pillar inner panel 11. The center pillar 1 has therein a closed cross-sectional space 10s extending in the up-down direction by joining respective front-edge flanges 10f and 11f of the pillar outer panel 10 and the pillar inner panel 11 to each other, and by joining respective rear-edge flanges 10r and 11r of the pillar outer panel 10 and the pillar inner panel 11 to each other.

A rear wheel well 85 is at the rear of the side sill 82. The rear wheel well 85 has an arch shape protruding upward, e.g., is concave, when viewed from the side of the vehicle to accommodate a rear wheel. The rear wheel well 85 includes a rear wheel well inner portion 86 and a rear wheel well outer portion 87. A front lower end 87a of the rear wheel well outer portion 87 joins the rear edge of the side sill 82.

A rear pillar 7 above the rear wheel well 85 extends obliquely downward from the rear edge of the roof rail 2 toward the rear direction. That is, the front upper end of the rear pillar 7 is joined to the rear edge of the roof rail 2. Note that the rear lower end of the rear pillar 7 is joined to the vehicle-width outer end of a rear end panel (not illustrated) extending in the vehicle width direction at the vehicle-body rear part.

When viewed from the side of the vehicle body, a side inner panel 88 is between the rear wheel well 85 and the rear pillar 7, and forms the side wall of a trunk. The side inner panel 88 is disposed with its lower portion interposed between the rear wheel well inner portion 86 and the rear wheel well outer portion 87. The peripheral edge of the rear wheel well 85 (mainly the upper part and the front part), except the lower part, is joined to the side inner panel 88.

As illustrated in FIG. 1, the side sill 82 and the roof rail 2 are connected by an intermediate pillar 4 (quarter pillar) extending in the up-down direction at a rearward position relative to the center pillar 1.

The lower end portion of the intermediate pillar 4 is joined to the rear wheel well outer portion 87 at the front relative to its top portion 87t. Further, a gusset 41, included in the intermediate pillar 4 at its lower end portion, extends downward toward the front direction along the front edge of the rear wheel well outer portion 87, and is joined to the rear edge of the side sill 82.

The intermediate pillar 4 includes an intermediate-pillar outer panel 42 with a hat shape opened toward the vehicle-width inner side, e.g., a convex portion 47 away from the front direction, when viewed in cross section perpendicular to the up-down direction (the longitudinal direction). The intermediate pillar 4 defines a closed cross-sectional space 4s extending in the up-down direction between the intermediate pillar 4 and the front portion of the side inner panel 88.

As illustrated in FIG. 1, in front of the center pillar 1 on the vehicle-body side part, a door opening portion 90F for a front-seat passenger to board and deboard the vehicle is formed by being surrounded by the center pillar 1, the front pillar 83, the hinge pillar 84, the roof rail 2, and the side sill 82.

At the rear of the center pillar 1 on the vehicle-body side part, a door opening portion 90R for a rear-seat passenger to board and deboard the vehicle is surrounded by the center pillar 1, the front edge of the rear wheel well 85 and the intermediate pillar 4, the roof rail 2, and the side sill 82.

Although not illustrated, the door opening portion 90F for a front-seat passenger to board and deboard the vehicle is configured to be opened/closed by a front door, while the door opening portion 90R for a rear-seat passenger to board and deboard the vehicle is configured to be opened/closed by a rear side door. Both the front side door and the rear side door include a door impact bar (not illustrated) extending in the vehicle front-rear direction so as to connect the front door edge corresponding to the front side door and the rear door edge corresponding to the rear side door.

The roof portion 20 is provided with a front header 26 and a rear header 27 that connect the roof rails 2 provided on both sides of the roof portion 20 to each other in the vehicle width direction at both the front and rear ends of the roof rails 2.

Between the front header 26 and the rear header 27 in the vehicle front-rear direction, a plurality of roof reinforcements 3 are spaced apart from each other in the vehicle front-rear direction and are approximately in parallel to each other. The opposite outer-side ends of the roof reinforcements 3 in the vehicle width direction are joined to their corresponding right-side and left-side roof rails 2. Further, the roof portion 20 is provided with the roof panel 28 (see FIG. 6(b)) that covers the front header 26, the rear header 27, and the roof reinforcements 3 from above. The roof panel 28 will be described later.

A joined portion C3f between the roof rail 2 and a front-side roof reinforcement 3f, which is one of a plurality of (two in this example) roof reinforcements 3 (3f and 3r), approximately aligns with a joined portion C1 between the roof rail 2 and the center pillar 1 in the vehicle front-rear direction.

Note that the vehicle includes a side outer panel 9 (see FIG. 6(b)) on its side part as an exterior component of the side part. The side outer panel 9 is a panel mounted in such a manner as to cover the side part of the vehicle, specifically, cover at least the roof rail 2, the side sill 82, the front pillar 83, the hinge pillar 84, the center pillar 1, and the intermediate pillar 4 integrally from the vehicle-width-direction outer side. The side outer panel 9 may be formed from a sheet of steel plate by press-molding the sheet into a predetermined shape and stamping out the sheet at the positions corresponding to the front and rear door opening portions 90F and 90R.

Next, the structure of relevant parts of the roof rail 2, the rear-side roof reinforcement 3r, and the intermediate pillar 4, and the structure of a joined portion C3r of the rear-side roof reinforcement 3r to the roof rail 2 and a joined portion C4 of the intermediate pillar 4 to the roof rail 2 are described in detail.

FIG. 2 is an enlarged cross-sectional view of the relevant parts taken along the line A-A in FIG. 1.

As illustrated in FIG. 2, the roof rail 2 includes a roof rail inner portion 21, and a roof rail outer portion 22 above the roof rail inner portion 21 on the vehicle-width outer side relative to the roof rail inner portion 21. The roof rail inner portion 21 includes a front-side roof rail inner portion 21f and a rear-side roof rail inner portion 21r having its front surface joined to a rear surface of the front-side roof rail inner portion 21f.

The roof rail inner portion 21 (the front-side and rear-side roof rail inner portions 21f and 21r) may be a single piece with a generally hat shape opened upward including a lower wall 21a protruding, e.g., convex, toward the vehicle-width outer side in cross section perpendicular to the longitudinal direction, an inner wall 21b extending obliquely upward from the vehicle-width inner end of the lower wall 21a toward the vehicle-width inner side, an inner-end flange 21d extending obliquely downward from the upper end of the inner wall 21b toward the vehicle-width inner side, an outer wall 21e extending obliquely upward from the vehicle-width outer end of the lower wall 21a toward the vehicle-width outer side, and an outer-end flange 21g extending obliquely downward from the upper end of the outer wall 21e toward the vehicle-width outer side.

The roof rail outer portion 22 may be a single piece with a generally hat shape (a generally G-shape) including an upper wall 22a protruding, e.g., convex, downward toward the vehicle-width inner side in cross section perpendicular to the longitudinal direction, an inner wall 22b extending obliquely downward from the vehicle-width inner end of the upper wall 22a toward the vehicle-width inner side, an inner-end flange 22d extending obliquely downward from the lower end of the inner wall 22b toward the vehicle-width inner side, an outer wall 22e extending obliquely downward from the vehicle-width outer end of the upper wall 22a toward the vehicle-width outer side, and an outer-end flange 22g extending obliquely downward from the lower end of the outer wall 22e toward the vehicle-width outer side.

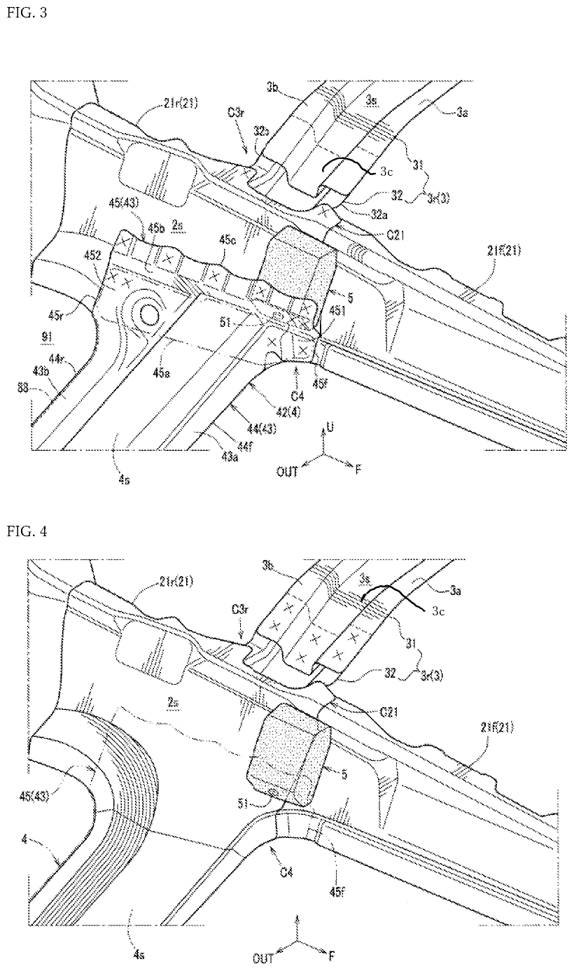

The roof rail 2 defines therein the closed cross-sectional space 2s (see FIGS. 3 and 4) extending in the vehicle front-rear direction by joining the respective inner-end flanges 21d and 22d of the roof rail inner portion 21 and the roof rail outer portion 22 to each other, and joining the respective outer-end flanges 21g and 22g of the roof rail inner portion 21 and the roof rail outer portion 22 to each other, e.g., by spot welding over a plurality of spots in the vehicle front-rear direction or the like.

As illustrated in FIG. 1, the intermediate-pillar outer panel 42 includes, at its upper portion, an intermediate-pillar outer upper panel 43 (hereinafter, abbreviated as “intermediate-pillar upper portion 43”) that serves as an upper-side intermediate pillar extending obliquely downward toward the rear to constitute the front side of an opening portion 91 for a quarter window. The intermediate-pillar upper 43 may be a single piece by an intermediate-pillar upper body portion 44 extending obliquely along the front side of the opening portion 91 for a quarter window, and an intermediate-pillar wider upper portion 45 joined to the roof rail 2, e.g., by spot welding or the like. The intermediate-pillar wider upper portion 45 protrudes upward with an increasing width toward the vehicle front side and the vehicle rear side relative to the upper end of the intermediate-pillar upper body portion 44.

FIG. 3 is an enlarged diagram of the joined portion C3r of the rear-side roof reinforcement 3r to the roof rail 2 and the joined portion C4 of the intermediate pillar 4 to the roof rail 2 in FIG. 1, and adjacent components. FIG. 3 illustrates the enlarged diagram with the roof rail outer portion 22 removed.

As illustrated in FIG. 3, the intermediate-pillar wider upper portion 45 of the intermediate-pillar upper 43 has a front-side extending portion 451 at the front part of the intermediate-pillar wider upper portion 45. The front-side extending portion 451 extends forward relative to a front edge 44f of the intermediate-pillar upper body portion 44. The intermediate-pillar wider upper portion 45 also has a rear-side extending portion 452 at the rear part of the intermediate-pillar wider upper portion 45. The rear-side extending portion 452 extends rearward relative to a rear edge 44r of the intermediate-pillar upper body portion 44. That is, in the intermediate-pillar wider upper portion 45 of the intermediate-pillar upper 43, a front edge 45f is positioned forward relative to the front edge 44f of the intermediate-pillar upper body portion 44, and a rear edge 45r is positioned rearward relative to the rear edge 44r of the intermediate-pillar upper body portion 44.

An upper-end flange 45c is formed at the upper end of the intermediate-pillar wider upper portion 45 in its entirety in the vehicle front-rear direction. A front-edge flange 43a along the front edge of the intermediate-pillar upper 43 extends continuously from the front edge 44f of the intermediate-pillar upper body portion 44 to the front-side extending portion 451 of the intermediate-pillar wider upper portion 45. A rear-edge flange 43b along the rear edge of the intermediate-pillar upper 43 extends continuously from the rear edge 44r of the intermediate-pillar upper body portion 44 to the rear-side extending portion 452 of the intermediate-pillar wider upper portion 45.

In other words, as illustrated in FIG. 3, the intermediate-pillar wider upper portion 45 of the intermediate-pillar upper 43 includes a base portion 45a extending upward from the upper end of the intermediate-pillar upper body portion 44 toward the vehicle-width inner side. Also, the upper-end flange 45c of the intermediate-pillar wider upper portion 45 extends upward from the upper end of the base portion 45a through a vertical-wall-like step portion 45b toward the vehicle-width inner side.

As illustrated in FIGS. 2 and 3, in the intermediate-pillar wider upper portion 45, the upper-end flange 45c is joined to the upper wall 22a of the roof rail outer portion 22, while the front-side extending portion 451 and the rear-side extending portion 452 in the base portion 45a are joined to the outer-end flange 22g of the roof rail outer portion 22 (see “x” in FIG. 3). As such, the intermediate-pillar wider upper portion 45 is joined to the roof rail outer portion 22 such that the inner surface of the step portion 45b butts against the outer wall 22e of the roof rail outer portion 22 from the vehicle-width-direction outer side from below, as illustrated in FIG. 2.

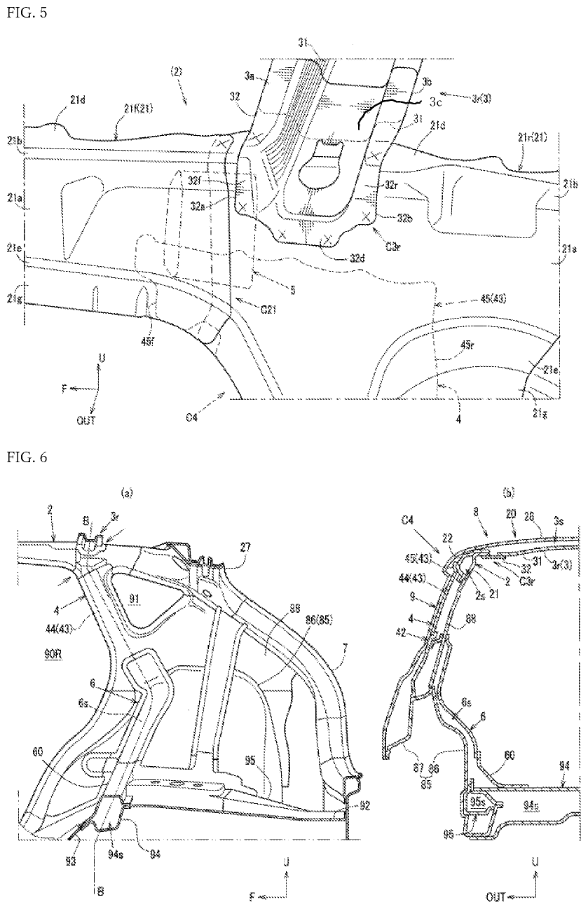

FIG. 4 is a perspective view with the intermediate-pillar upper 43 in FIG. 3 removed. FIG. 5 is a perspective view of the joined portion C3r of the roof rail 2 with the rear-side roof reinforcement 3r, and the joined portion C4 of the roof rail 2 with the intermediate pillar 4 when viewed from below.

As illustrated in FIGS. 3 to 5, the rear-side roof reinforcement 3r includes a roof reinforcement body portion 31 and a gusset 32. The gusset 32 is joined at its vehicle-width inner end to the vehicle-width outer end of the roof reinforcement body portion 31, e.g., by spot welding or the like (see “x” in FIG. 4).

The roof reinforcement body portion 31 and the gusset 32 both have a hat shape opened upward, e.g., a convex central portion 3c with flanges 3a, 3b on either side thereof, when viewed in cross section perpendicular to the vehicle width direction (the longitudinal direction). The rear-side roof reinforcement 3r has a front-edge flange 3a on its front side, and a rear-edge flange 3b on its rear side, the respective upper surfaces of which are fixed to the lower surface of the roof panel 28 using an adhesive (not illustrated), and the rear-side roof reinforcement 3r defines a closed cross-sectional space 3s extending in the vehicle width direction between the front-edge and rear-edge flanges 3a and 3b in cooperation with the roof panel 28 (see FIG. 6(b)).

As illustrated in FIG. 5, the rear-side roof reinforcement 3r is joined to the rear part of the roof rail inner portion 21.

Specifically, the front edge and the rear edge of the gusset 32 are both joined to the inner-end flange 21d of the roof rail inner portion 21 from the vehicle-width inner side from below by spot welding (see “x” in FIGS. 3 and 5). Further, on the front edge, the rear edge, and the lower edge of the gusset 32 at its vehicle-width outer end, a front-edge flange 32f, a rear-edge flange 32r, and a lower-edge flange 32d are formed, respectively. Each of the flanges 32f, 32r, and 32d is joined to the lower wall 21a of the roof rail inner portion 21 from its vehicle-width inner side by spot welding (see “x” in FIGS. 3 and 5).

As illustrated in FIGS. 1 to 5, 6(a), and 6(b), the joined portion C3r between the roof rail 2 and the rear-side roof reinforcement 3r approximately aligns with the joined portion C4 between the roof rail 2 and the intermediate pillar 4 in the vehicle front-rear direction.

In this example, as illustrated in FIGS. 3 and 5, the gusset 32 of the rear-side roof reinforcement 3r is narrower in the vehicle front-rear direction than the intermediate-pillar wider upper portion 45 of the intermediate pillar 4. The front edge 32a of the gusset 32 of the rear-side roof reinforcement 3r is positioned rearward relative to the front edge 45f of the intermediate-pillar wider upper portion 45. The rear edge 32b of the gusset 32 of the rear-side roof reinforcement 3r is positioned forward relative to the rear edge 45r of the intermediate-pillar wider upper portion 45.

As illustrated in FIGS. 2 to 5, in the closed cross-sectional space 2s, at a section corresponding to at least a part of the joined portion C4 of the roof rail 2 with the intermediate pillar 4 in the longitudinal direction of the roof rail 2, a high-rigidity filler 5 (hereinafter, referred to as “filler 5”) is disposed to serve as a deformation suppression member that suppresses a change in shape of the roof rail 2 in cross section perpendicular to the longitudinal direction of the roof rail 2.

The filler 5 may be a hard, high-strength foam, e.g., a foam resin. For example, the foam resin may be a polyurethane resin, epoxy resin, or other type of resin that is foamed (expanded) by heat, and has, e.g., a three-fold or less foaming factor.

As illustrated in FIG. 2, the filler 5 almost completely fills the closed cross-sectional space 2s of the roof rail 2 when viewed in cross section perpendicular to the vehicle front-rear direction, so that a change in shape of the roof rail 2 in cross section perpendicular to the longitudinal direction is suppressed at a location where the filler 5 is provided, and at the front and rear periphery of the location.

In this example, the filler 5 is disposed in the closed cross-sectional space 2s corresponding to the front-side section of the joined portion C4 of the roof rail 2 with the intermediate pillar 4 in the longitudinal direction.

More specifically, as illustrated in FIG. 3, in the longitudinal direction of the roof rail 2, between the rear edge 32b of the joined portion C3r of the rear-side roof reinforcement 3r (the rear edge 32b of the gusset 32 of the rear-side roof reinforcement 3r) and the front edge 45f of the joined portion C4 with the intermediate pillar 4 (the front edge 45f of the intermediate-pillar wider upper portion 45), the filler 5 extends forward and rearward relative to the front edge 32a of the joined portion C3r with the rear-side roof reinforcement 3r (the front edge 32a of the gusset 32 of the rear-side roof reinforcement 3r).

That is, in the longitudinal direction of the roof rail 2, the filler 5 at least partially overlaps the joined portion C3r with the rear-side roof reinforcement 3r and the joined portion C4 with the intermediate pillar 4.

In the closed cross-sectional space 2s of the roof rail 2, at a location where the filler 5 is provided, the filler 5 is in contact, e.g., direct contact, with a panel-like wall that constitutes the roof rail 2, in this example, an inner surface of the outer wall 22e of the roof rail outer portion 22 and an inner surface of the roof rail inner portion.

Specifically, the filler 5 before being foamed is formed like a plate, and one end portion (base end portion) of the plate is formed with an engagement piece 51 (see FIGS. 2 to 4) protruding from the one end portion. In contrast, at the attachment location for the filler 5 on the inner surface of the outer wall 22e of the roof rail outer portion 22, an engagement hole 23 (see FIG. 2) is formed as a through hole into which the engagement piece 51 can be inserted.

In a vehicle-body production process, a painting process of electropainting an electrodeposition liquid on the vehicle body is performed after a vehicle-body assembling process. After the electropainting process in which the vehicle body is immersed in this electrodeposition liquid, a drying process is performed in which the vehicle body is led into a heating furnace and is heated at a predetermined temperature for a given time in order to dry the electrodeposition liquid.

In this example, in the vehicle-body assembling process, the engagement piece 51 included in the base end portion of the plate-like filler 5 before being foamed is inserted into the engagement hole 23 provided at the attachment location for the filler 5, e.g., on the outer wall 22e of the roof rail outer portion 22. Thus the engagement piece 51 is engaged with the peripheral edge of the engagement hole 23. The filler 5 is thereby attached to the above attachment location on the roof rail outer portion 22 in such a manner as to face the closed cross-sectional space 2s. In the drying step, heat of the drying furnace is used to foam (expand) the filler 5, bringing the filler 5 into press-contact (close-contact) with the inner surfaces of the roof rail 2, which define the closed cross-sectional space 2s.

As illustrated in FIGS. 2 and 3, the filler 5 is provided with its front edge positioned rearward relative to the front edge of the intermediate-pillar wider upper portion 45 of the intermediate pillar 4, as described above. Thus, the filler 5 in its entirety in the vehicle front-rear direction is covered from the vehicle-width outer side by the intermediate-pillar wider upper portion 45 (mainly the front-side extending portion 451) through the roof rail outer portion 22.

As illustrated in FIGS. 2 to 5, a joined portion C21 between the front-side roof rail inner portion 21f and the rear-side roof rail inner portion 21r is between the front edge 45f of the intermediate-pillar wider upper portion 45 (the front edge 45f of the joined portion C4 of the intermediate pillar 4 with the roof rail 2) and the front edge 32a of the gusset 32 of the rear-side roof reinforcement 3r (the front edge 32a of the joined portion C3r of the rear-side roof reinforcement 3r with the roof rail 2) in the vehicle front-rear direction.

The filler 5 is provided in the vehicle front-rear direction so as to extend across the joined portion C21 between the front-side roof rail inner portion 21f and the rear-side roof rail inner portion 21r.

As illustrated in FIG. 3, the joined portion C21 between the front-side roof rail inner portion 21 and the rear-side roof rail inner portion 21r is positioned rearward relative to the front edge 45f of the intermediate-pillar wider upper portion 45 and forward relative to the front edge 44f of the intermediate-pillar upper body portion 44. In other words, the joined portion C21 is positioned across the front-side extending portion 451 of the intermediate-pillar wider upper portion 45 in the vehicle front-rear direction.

Meanwhile, as illustrated in FIGS. 1 and 6(a), the rear part of the vehicle according to the present embodiment includes, at its lower portion, a rear seat panel 92 on which a rear seat (not illustrated) is installed, and a rear floor panel 93 for forming the trunk. At the boundary portion between the rear seat panel 92 and the rear floor panel 93, a crossmember 94 is provided and defines therein a closed cross-sectional space extending in the vehicle width direction. As illustrated in FIGS. 1, 6(a), and 6(b), the rear seat panel 92 and the rear floor panel 93 are provided with a rear side frame 95 on both sides. The rear side frame 95 defines therein a closed cross-sectional space 95s (see FIG. 6(b)) extending in the vehicle front-rear direction.

The rear side frame 95 extends in the vehicle front-rear direction on the vehicle-interior side of the rear wheel well 85. The front edge portion of the rear side frame 95 is joined to the rear portion of the side sill 82.

As illustrated in FIGS. 6(a) and 6(b), a vehicle-interior-side up-down-direction reinforcement member 6 extends in the up-down direction on the vehicle-interior side of the side portion of the rear part of the vehicle according to the present embodiment. The vehicle-interior-side up-down-direction reinforcement member 6 extends upward from the height position of the rear side frame 95 so as to extend across the upper peripheral edge of the rear wheel well inner portion 86 in the up-down direction. The vehicle-interior-side up-down-direction reinforcement member 6 has a closed cross-sectional space 6s extending in the up-down direction between the vehicle-interior-side up-down-direction reinforcement member 6, and the rear wheel well inner portion 86 as well as the side inner panel 88 (see FIG. 6(b)).

Further, as illustrated in FIG. 6(b), the vehicle-interior-side up-down-direction reinforcement member 6 extends upward along the side inner panel 88 to a height position corresponding to the lower end portion of the intermediate-pillar upper 43 provided on the vehicle-width outer side.

That is, the vehicle-interior-side up-down-direction reinforcement member 6 is connected at its upper end portion to the lower end portion of the intermediate-pillar upper 43 through the side inner panel 88.

As described above, the upper end of the intermediate-pillar upper 43 is connected to the rear-side roof reinforcement 3r through the roof rail 2 extending in the vehicle front-rear direction. In contrast, as illustrated in FIGS. 6(a) and 6(b), the vehicle-interior-side up-down-direction reinforcement member 6 is joined to the intermediate portion of the rear side frame 95 in the vehicle front-rear direction, and to the vehicle-width outer end of the crossmember 94 through a gusset 60 provided at the lower portion of the vehicle-interior-side up-down-direction reinforcement member 6 in the vehicle-body lower part.

In this manner, in the vehicle body, at a section corresponding to the joined portion C3r with the rear-side roof reinforcement 3r, and the joined portion C4 with the intermediate pillar 4 in the front-rear direction of the vehicle body, the roof rails 2 on both sides, the rear-side roof reinforcement 3r, the intermediate pillar 4 (the intermediate-pillar upper 43), the vehicle-interior-side up-down-direction reinforcement member 6, the rear side frame 95, and the crossmember 94 serve as a plurality of closed cross-sectional members having therein their respective closed cross-sectional spaces.

As illustrated in FIGS. 1 and 6(b), in the vehicle body, at a section corresponding to the above joined portions C3r and C4 in the front-rear direction of the vehicle body, an annular structure 8 made up of these closed cross-sectional members 2, 3, 4, 6, 94, and 95 annularly surrounds a vehicle interior space when viewed from the front of the vehicle body.

The filler 5 is provided in or in the vicinity of a section of the roof rail 2 in the longitudinal direction, which constitutes a part of the annular structure 8 in the circumferential direction, e.g., in space 2s. In this example, the filler 5 is provided from a section of the roof reinforcement 3 in the vehicle front-rear direction, which constitutes a part of the annular structure 8, to the front vicinity of the section (see FIG. 3).

The upper vehicle-body structure for a vehicle according to the present embodiment described above is an upper vehicle-body structure for a vehicle (see FIG. 1), the structure including: the roof rail 2 included in the vehicle-body upper side part so as to constitute the side part of the roof portion 20 (roof) of the vehicle, the roof rail 2 having the closed cross-sectional space 2s (internal space) defined therein, the closed cross-sectional space 2s extending in a generally vehicle front-rear direction; the center pillar 1 serving as a first pillar extending downward from the roof rail 2; the intermediate pillar 4 serving as a second pillar extending downward from the roof rail 2 at a rearward position relative to the center pillar 1; and the rear-side roof reinforcement 3r (roof reinforcement) extending from the roof rail 2 toward a vehicle-width-direction inner side at a rearward position relative to the center pillar 1, wherein the upper vehicle-body structure includes, in the closed cross-sectional space 2s, the filler 5 serving as a deformation suppression member that suppresses a change in shape of the roof rail 2 in cross section perpendicular to a longitudinal direction of the roof rail 2 by coming into press-contact with a surface of the roof rail 2, the surface defining the closed cross-sectional space 2s, and in a longitudinal direction of the roof rail 2, between the rear edge 32b of the joined portion C3r of the roof rail 2 with the rear-side roof reinforcement 3r (that is, the rear edge 32b of the gusset 32) and the front edge 45f of the joined portion C4 of the roof rail 2 with the intermediate pillar 4 (that is, the front edge 45f of the intermediate-pillar wider upper portion 45), the filler 5 is provided over a region extending forward and rearward relative to the front edge 32a of the joined portion C3r of the roof rail 2 with the rear-side roof reinforcement 3r (that is, the front edge 32a of the gusset 32) (see FIGS. 2 and 3).

To be more specific, the filler 5 may continuously extend in a region forward and rearward relative to the front edge 32a of the joined portion C3r of the rear-side roof reinforcement 3r with the roof rail 2. Further, the filler 5 is provided in such a region that its rear edge is positioned forward relative to the rear edge 32b of the joined portion C3r of the rear-side roof reinforcement 3r with the roof rail 2, and its front edge is positioned rearward relative to the front edge 45f of the joined portion C4 of the intermediate pillar 4 with the roof rail 2.

At the time of a side collision, for example, a load input to the center pillar 1 is transmitted to the joined portion C3r of the roof rail 2 with the rear-side roof reinforcement 3r in some cases through a route directed rearward from the joined portion C1 of the roof rail 2 with the center pillar 1 in the longitudinal direction, or through a route directed upward from the door impact bar of the rear side door (not illustrated) along the intermediate pillar 4.

The joined portion C3r of the roof rail 2 with the rear-side roof reinforcement 3r corresponds to a section of the roof rail 2, which is supported by the rear-side roof reinforcement 3r. For example, the front of the joined portion C3r corresponds to a section of the roof rail 2, which extends forward from the joined portion C3r in a cantilevered manner without being supported by the rear-side roof reinforcement 3r. Due to this configuration, at the time of a side collision, when a side-collision load is transmitted to the joined portion C3r of the roof rail 2 with the rear-side roof reinforcement 3r as described above, there is a concern about breakage of the roof rail 2 at its unjoined portion (a portion immediately in front of the joined portion C3r) in the front vicinity of the joined portion C3r, that is, cross-sectional deformation of the roof rail 2 at its unjoined portion, caused by a stress that becomes concentrated between the joined portion C3r and the unjoined portion in front of the joined portion C3r due to the difference in rigidity therebetween.

To address this concern, the filler 5 is provided over a region extending forward and rearward relative to the front edge 32a of the joined portion C3r in the longitudinal direction of the roof rail 2 as described above. That is, the filler 5 connects the joined portion C3r on the rearward side relative to the front edge 32a of the joined portion C3r, and an easily breakable section (the unjoined portion) on the forward side relative to the front edge 32a of the joined portion C3r in the longitudinal direction of the roof rail 2. The joined portion C3r is supported by the rear-side roof reinforcement 3r and is thus highly rigid, while the easily breakable section is not supported by the rear-side roof reinforcement 3r and is thus easily breakable because a load is more likely to become concentrated on this section. However, due the presence of the filler 5, at the time of a side collision, cross-sectional deformation at the unjoined portion in the front vicinity of the joined portion C3r can be effectively suppressed against a load transmitted to the joined portion C3r of the roof rail 2 with the rear-side roof reinforcement 3r.

The filler 5 may be provided only in the region between the rear edge 32b of the joined portion C3r and the front edge 45f of the joined portion C4. For example, the filler 5 may be provided along the flange 3a to the front edge 45fd of the joined portion C4 as shown in FIGS. 2-5. Alternatively, the filler 5 may extend along some or all of the convex central portion 3c to the front edge 45fd of the joined portion C4 or along an entirety of the region between the rear edge 32b of the joined portion C3r and the front edge 45f of the joined portion C4. Thus, the filler 5 can effectively suppress breakage of the roof rail 2 at the joined portion C3r with the rear-side roof reinforcement 3r caused by a load transmitted to the joined portion C3r of the roof rail 2 with the rear-side roof reinforcement 3r at the time of a side collision, while minimizing an increase in weight of the roof rail 2.

In accordance with this aspect, the filler 5 is the high-rigidity foamed element that is foamed by heat (FIGS. 2 to 4).

According to the above configuration, the high-rigidity filler 5 can be foamed using heat in the process of drying an electrodeposition liquid (painting agent) painted on the vehicle-body surface. Thus, while an increase in weight of the roof rail 2 is minimized, the high-rigidity filler 5 can be easily filled in the closed cross-sectional space 2s of the roof rail 2 in such a manner that the filler 5 comes into press-contact with the surface defining the closed cross-sectional space 2s.

In accordance with this aspect, the joined portion C3r of the roof rail 2 with the rear-side roof reinforcement 3r aligns with the joined portion C4 of the roof rail 2 with the intermediate pillar 4 at least partially in the longitudinal direction of the roof rail 2 (see FIGS. 1 to 6), the vehicle body is provided with a plurality of the closed cross-sectional members 2, 3, 4, 6, 94, and 95 having therein the closed cross-sectional spaces 2s, 3s, 4s, 6s, 94s, and 95s (see FIG. 6(b)) respectively, and in and around a section where the joined portion C3r of the roof rail 2 with the rear-side roof reinforcement 3r aligns with the joined portion C4 of the roof rail 2 with the intermediate pillar 4 in a vehicle-body front-rear direction, the annular structure 8 is made up of the closed cross-sectional members 2, 3, 4, 6, 94, and 95 disposed so as to annularly surround the vehicle-interior space when viewed from the front of the vehicle body (see FIGS. 1 and 6(b)). The filler 5 can be provided in or in the vicinity of a section of the roof rail 2 in the longitudinal direction, which constitutes a part of the annular structure 8 (see FIG. 2).

According to the above configuration, the filler 5 is provided in or in the vicinity of a section of the roof rail 2 in the longitudinal direction, which constitutes a part of the annular structure 8, so that the filler 5 can suppress cross-sectional deformation at the section of the roof rail 2 in the longitudinal direction. This can contribute to improvement in rigidity of the annular structure 8.

In accordance with this aspect, the intermediate pillar 4 can include the intermediate-pillar upper 43 (mainly the front-side extending portion 451 of the intermediate-pillar wider upper portion 45) serving as a second-pillar outer panel in a joined portion with the roof rail 2 at least from the front edge to the rear edge of the filler 5 on a vehicle-width-direction outer side relative to the filler 5 (see FIG. 3).

According to the above configuration, the intermediate-pillar upper 43 can be provided so as to cover the filler 5 in its entirety in the vehicle front-rear direction from the vehicle-width outer side mainly by the intermediate-pillar wider upper portion 45 of the intermediate-pillar upper portion 43. Therefore, at the time of a side collision, for example, a side-collision load input to the center pillar 1 and transmitted from the intermediate-pillar wider upper portion 45 included in the intermediate-pillar upper portion 43 of the intermediate pillar 4 to the roof rail 2 via the door impact bar of the rear side door can be received by the filler 5 in its entirety in the vehicle front-rear direction. The filler 5 can thus suppress cross-sectional deformation of a section of the roof rail 2 in the longitudinal direction corresponding to the joined portion C4 with the intermediate pillar 4.

In accordance with this aspect, the roof rail inner portion 21 includes the front-side roof rail inner portion 21f (front-side roof-rail constituent member) and the rear-side roof rail inner portion 21r (rear-side roof-rail constituent member) with a front edge thereof joined to a rear edge of the front-side roof rail inner portion 21f (see FIGS. 2 to 5). The filler 5 may be provided at a position corresponding to the joined portion C21 of the front-side roof rail inner portion 21f and the rear-side roof rail inner portion 21r in the longitudinal direction of the roof rail 2 such that the filler 5 extends across the joined portion C21 in the vehicle front-rear direction (see FIGS. 2 to 5).

According to the above configuration, the filler 5 extends across the joined portion C21 between the front-side roof rail inner portion 21f and the rear-side roof rail inner portion 21r in the vehicle front-rear direction. Thus, the filler 5 can come into press-contact with the inner surface of the roof rail 2, which defines the closed cross-sectional space 2s, such that the rear edge of the front-side roof rail inner portion 21f and the front edge of the rear-side roof rail inner portion 21r overlap one another in the joined portion C21. Accordingly, at the time of a side collision, efficiency in transmitting and dispersing a side-collision load mutually between the front-side roof rail inner portion 21f and the rear-side roof rail inner portion 21r can be improved.

Note that the roof rail inner portion 21 is divided into, and made up of, at least the front-side roof rail inner portion 21f and the rear-side roof rail inner portion 21r in the vehicle front-rear direction. Thus, between the front-side and the rear-side roof rail portions 21f and 21r, and their opposed constituent member in the vehicle width direction, i.e., the roof rail outer portion 22, an adequate number of joining spots for spot welding or the like are secured, while the joining spots are provided at appropriate places, and then the inner-end flanges 21d and 22d can be joined to each other, and the outer-end flanges 21g and 22g can be joined to each other.

As such, the constituent members of the roof rail 2 can be more firmly joined to a constituent member opposed to these constituent members in the vehicle width direction, as compared to the case where the roof rail 2 is formed of a single member along the vehicle front-rear direction.

By way of summation and review, embodiments suppress breakage of a roof rail at its joined portion with a roof rail reinforcement caused by a vehicle-width-direction inner side load applied to a first pillar, e.g., a center pillar, at the time of a side collision, while minimizing an increase in weight of the roof rail.

Example embodiments have been disclosed herein, and although specific terms are employed, they are used and are to be interpreted in a generic and descriptive sense only and not for purpose of limitation.

For example, the first pillar is not limited to the center pillar, but may be other pillars, e.g., a front pillar as long as the first pillar extends downward from the roof rail at the front relative to the joined portion of this roof rail with the roof reinforcement (the rear-side roof reinforcement 3r). That is, the upper vehicle-body structure according embodiments may be applicable to a vehicle that does not have a center pillar.

A load to be transmitted to the joined portion of the roof rail with the roof reinforcement (the rear-side roof reinforcement 3r) at the time of a side collision is not limited to being based on the vehicle-width-direction inner side load input to the center pillar. The load may be based on any vehicle-width-direction inner side load input to the vehicle-body side part at the time of a side collision, such as a load to be transmitted from the second pillar to the roof rail not through the center pillar, or a load to be transmitted from the front relative to the joined portion of the roof rail with the roof reinforcement along the roof reinforcement to the joined portion with the roof reinforcement.

### DESCRIPTION OF SYMBOLS

1 . . . Center pillar (First pillar)
2 . . . Roof rail (Closed cross-sectional member)
2s . . . Closed cross-sectional space (Interior space)
2s, 3s, 4s, 6s, 94s, 95s . . . Closed cross-sectional space
included in closed cross-sectional member
3r . . . Rear-side roof reinforcement (Roof reinforcement,
Closed cross-sectional member)
4 . . . Intermediate pillar (Second pillar)
5 . . . High-rigidity foamed element (Deformation suppression member)
6 . . . Vehicle-interior-side up-down-direction reinforcement member (Closed cross-sectional member)
8 . . . Annular structure
20 . . . Roof portion (Roof)
21f . . . Front-side roof rail inner (Front-side roof-rail constituent member)
21r . . . Rear-side roof rail inner (Rear-side roof-rail constituent member)
32a . . . Front edge of joined portion of rear-side roof reinforcement with roof rail (Front edge of connection portion of roof reinforcement with roof rail)
32b . . . Rear edge of joined portion of rear-side roof reinforcement with roof rail (Rear edge of connection portion of roof reinforcement with roof rail)
43 . . . Intermediate-pillar outer upper panel (Second-pillar outer panel, Closed cross-sectional member)
45f . . . Front edge of joined portion of intermediate pillar with roof rail (Front edge of connection portion of second pillar with roof rail)
95 . . . Rear side frame (Closed cross-sectional member)
94 . . . Crossmember (Closed cross-sectional member)
C3r . . . Joined portion of rear-side roof reinforcement with roof rail (Connection portion of roof reinforcement with roof rail)
C4 . . . Joined portion of rear-side roof reinforcement with intermediate pillar (Connection portion of roof reinforcement with second pillar)
C21 . . . Joined portion between front-side roof rail inner and rear-side roof rail inner (Connection portion of front-side and rear-side roof-rail constituent members)

1. An upper vehicle-body structure for a vehicle, the structure comprising:
a roof rail included in a vehicle-body upper side part, the roof rail serving as a side part of a roof of the vehicle, the roof rail having an internal space defined therein, the internal space extending in a generally vehicle front-rear direction;
a first pillar extending downward from the roof rail;
a second pillar extending downward from the roof rail at a rearward position relative to the first pillar;
a roof reinforcement extending from the roof rail toward a vehicle-width-direction inner side at a rearward position relative to the first pillar; and
a filler in the internal space, the filler to suppress a change in shape of the roof rail in cross section perpendicular to a longitudinal direction of the roof rail, the filler being in contact with an inner surface of the roof rail, the inner surface defining the internal space, wherein
the filler is in a region extending forward and rearward relative to a front edge of a connection portion of the roof rail with the roof reinforcement.

2. The upper vehicle-body structure for a vehicle according to claim 1, wherein the filler is a high-rigidity foam.

3. The upper vehicle-body structure for a vehicle according to claim 2, wherein
the connection portion of the roof rail with the roof reinforcement at least partially aligns with a connection portion of the roof rail with the second pillar in a longitudinal direction of the roof rail,
a vehicle body includes a plurality of closed cross-sectional members having respective closed cross-sectional spaces, and in and around a section where the connection portion of the roof rail with the roof reinforcement aligns with the connection portion of the roof rail with the second pillar in a vehicle-body front-rear direction, an annular structure formed of the closed cross-sectional members that annularly surround a vehicle-interior space when viewed from front of the vehicle body,
the roof rail, the roof reinforcement, and the second pillar are included in the closed cross-sectional members, and respectively have the closed-cross sectional spaces defined therein, and
the filler is provided in or in a vicinity of a section of the roof rail, the section constituting a part of the annular structure.

4. The upper vehicle-body structure for a vehicle according to claim 3, wherein the second pillar includes a second-pillar outer panel in a connection portion with the roof rail at least from a front edge to a rear edge of the filler on a vehicle-width-direction outer side relative to the filler.

5. The upper vehicle-body structure for a vehicle according to claim 4, wherein
the roof rail includes a front-side roof-rail inner portion and a rear-side roof-rail outer portion with a front edge thereof connected to a rear edge of the front-side roof-rail inner portion, and
the upper vehicle-body structure includes the filler at a connection portion of the front-side inner and rear-side roof-rail outer portions in a longitudinal direction of the roof rail such that the filler extends across the connection portion in a vehicle front-rear direction.

6. The upper vehicle-body structure for a vehicle according to claim 3, wherein
the roof rail includes a front-side roof-rail inner portion and a rear-side roof-rail outer portion with a front edge thereof connected to a rear edge of the front-side roof-rail inner portion, and
the upper vehicle-body structure includes the filler at a connection portion of the front-side inner and rear-side roof-rail outer portions in a longitudinal direction of the roof rail such that the filler extends across the connection portion in a vehicle front-rear direction.

7. The upper vehicle-body structure for a vehicle according to claim 2, wherein
the roof rail includes a front-side roof-rail inner portion and a rear-side roof-rail outer portion with a front edge thereof connected to a rear edge of the front-side roof-rail inner portion, and
the upper vehicle-body structure includes the filler at a connection portion of the front-side inner and rear-side roof-rail outer portions in a longitudinal direction of the roof rail such that the filler extends across the connection portion in a vehicle front-rear direction.

8. The upper vehicle-body structure for a vehicle according to claim 1, wherein
the connection portion of the roof rail with the roof reinforcement at least partially aligns with a connection portion of the roof rail with the second pillar in a longitudinal direction of the roof rail,
a vehicle body includes a plurality of closed cross-sectional members having respective closed cross-sectional spaces, and in and around a section where the connection portion of the roof rail with the roof reinforcement aligns with the connection portion of the roof rail with the second pillar in a vehicle-body front-rear direction, an annular structure formed of the closed cross-sectional members that annularly surround a vehicle-interior space when viewed from front of the vehicle body,
the roof rail, the roof reinforcement, and the second pillar are included in the closed cross-sectional members, and respectively have the closed-cross sectional spaces defined therein, and
the filler is provided in or in a vicinity of a section of the roof rail, the section constituting a part of the annular structure.

9. The upper vehicle-body structure for a vehicle according to claim 8, wherein the second pillar includes a second-pillar outer panel in a connection portion with the roof rail at least from a front edge to a rear edge of the filler on a vehicle-width-direction outer side relative to the filler.

10. The upper vehicle-body structure for a vehicle according to claim 9, wherein
the roof rail includes a front-side roof-rail inner portion and a rear-side roof-rail outer portion with a front edge thereof connected to a rear edge of the front-side roof-rail inner portion, and
the upper vehicle-body structure includes the filler at a connection portion of the front-side inner and rear-side roof-rail outer portions in a longitudinal direction of the roof rail such that the filler extends across the connection portion in a vehicle front-rear direction.

11. The upper vehicle-body structure for a vehicle according to claim 8, wherein
the roof rail includes a front-side roof-rail inner portion and a rear-side roof-rail outer portion with a front edge thereof connected to a rear edge of the front-side roof-rail inner portion, and
the upper vehicle-body structure includes the filler at a connection portion of the front-side inner and rear-side roof-rail outer portions in a longitudinal direction of the roof rail such that the filler extends across the connection portion in a vehicle front-rear direction.

12. The upper vehicle-body structure for a vehicle according to claim 1, wherein
the roof rail includes a front-side roof-rail inner portion and a rear-side roof-rail outer portion with a front edge thereof connected to a rear edge of the front-side roof-rail inner portion, and
the upper vehicle-body structure includes the filler at a connection portion of the front-side inner and rear-side roof-rail outer portions in a longitudinal direction of the roof rail such that the filler extends across the connection portion in a vehicle front-rear direction.

13. The upper vehicle-body structure for a vehicle according to claim 1, wherein the region extends further in the rearward direction than in the forward direction relative to the front edge of the connection portion of the roof rail with the roof reinforcement.

14. The upper vehicle-body structure for a vehicle according to claim 1, wherein a connection portion of the roof rail with the second pillar extends further forward than the connection portion of the roof rail with the roof reinforcement.

15. The upper vehicle-body structure for a vehicle according to claim 1, wherein the region is positioned forward relative to a rear edge of a connection between the roof reinforcement with the roof rail and rearward relative to a front edge of a connection between the second pillar with the roof rail.

16. The upper vehicle-body structure for a vehicle according to claim 1, wherein the roof rail includes a roof rail inner portion and a roof rail outer portion defining the internal space.

17. An upper vehicle-body structure for a vehicle, the structure comprising:
a roof rail included in a vehicle-body upper side part, the roof rail serving as a side part of a roof of the vehicle, the roof rail having an internal space defined therein, the internal space extending in a generally vehicle front-rear direction;
a pillar extending downward from the roof rail;
a roof reinforcement extending from the roof rail toward a vehicle-width-direction inner side; and
a filler in the internal space, the filler being in contact with an inner surface of the roof rail, the inner surface defining the internal space, wherein
a connection portion of the roof rail with the roof reinforcement at least partially aligns with a connection portion of the roof rail with the pillar in a longitudinal direction of the roof rail, and
the filler is in a region extending forward and rearward relative to a front edge of the connection portion of the roof rail with the roof reinforcement.

18. The upper vehicle-body structure for a vehicle according to claim 17, wherein the region extends further in the rearward direction than in the forward direction relative to the front edge of the connection portion of the roof rail with the roof reinforcement.

19. The upper vehicle-body structure for a vehicle according to claim 17, wherein the connection portion of the roof rail with the pillar extends forward further than the connection portion of the roof rail with the roof reinforcement.

20. The upper vehicle-body structure for a vehicle according to claim 17, wherein the filler is a high-rigidity foam.
